(19) United States
(12) Patent Application Publication
(10) Pub. No.: US 2026/0267580 A1
(43) Pub. Date: Sep. 10, 2026

(54) INTERACTIVE CONTROL METHOD AND APPARATUS, AND ELECTRONIC DEVICE

(71) Applicant: GOERTEK INC., Weifang, Shandong (CN)

(72) Inventors: Yufeng LI, Weifang, Shandong (CN); Gaojian SHI, Weifang, Shandong (CN)

(21) Appl. No.: 18/994,908

(22) PCT Filed: Aug. 8, 2023
(86) PCT No.: PCT/CN2023/111789

§ 371 Date: Jan. 15, 2025

(30) Foreign Application Priority Data
Sep. 29, 2022 (CN) 202211213281.X

(51) Int. Cl. G06F 3/14; G06F 3/0346; G06F 3/04817; G06F 3/0482; G06F 3/0488

(52) U.S. Cl. CPC G06F 3/14; G06F 3/0346; G06F 3/04817; G06F 3/0482; G06F 3/0488

(57) ABSTRACT

Disclosed an interactive control method comprises: acquiring application attribute information of local applications of a terminal device; displaying icons and names of the local applications in a display area of a head-mounted display device; on the basis of a detected ray event sent by the terminal device, determining the icon and name of an i-th application from among the displayed icons and names of the local applications, to activate the i-th application; establishing an i-th canvas area corresponding to the i-th application in the display area, and recording a mapping relationship between the i-th canvas area and application attribute information of the i-th application; and sending the mapping relationship to the terminal device, so that the terminal device activates an i-th virtual screen to run the i-th application, acquires display data of the i-th virtual screen, and sends the display data to the i-th canvas area for display.

This application claims priority to the Chinese patent application No. 202211213281.X, entitled “INTERACTIVE CONTROL METHOD AND APPARATUS, AND ELECTRONIC DEVICE”, filed with the China Patent Office on Sep. 29, 2022, the entire contents of which are incorporated herein by reference.

### TECHNICAL FIELD

The embodiments of the present disclosure relate to the technical field of wearable devices. More specifically, the embodiments of the present disclosure relate to an interactive control method, an interactive control apparatus, and an electronic device.

### BACKGROUND

With the continuous development of augmented reality (AR) technology, major manufacturers have launched more and more AR products and AR applications. Wireless streaming technology is a common technology in AR products such as AR glasses. Users use wireless streaming technology to transmit the content on the mobile phone screen to AR glasses. Using the inertial measurement unit (IMU) in the mobile phone as a handle to control AR glasses is an interactive method. The mobile phone transmits the posture information of the IMU to the AR glasses to control the ray for interaction.

However, in this case, when the mobile phone IMU is used as a handle control, the controller application has to run in the foreground, causing the physical screen of the mobile phone to be occupied at all time, and other applications cannot be streamed to the AR glasses. If other applications are activated for streaming, the control module will not be able to be used normally because the controller application enters the background. Secondly, due to the infinite space characteristics of AR glasses, the application in the mobile phone can completely transmit the information of multiple applications in the AR glasses, so that multiple applications can be activated at the same time, such as watching movies and working in the foreground. However, existing technologies make it difficult to achieve such usage scenarios.

### SUMMARY

The purpose of the embodiments of the present disclosure is to provide an interactive control method, apparatus and electronic device.

According to a first aspect of the present disclosure, there is provided an interactive control method, wherein the method includes:
acquiring application attribute information of local applications of a terminal device, wherein the application attribute information includes at least an icon and a name of a local application;
displaying the icons and the names of the local applications in a display area of a head mounted display device;
determining an icon and a name of an i-th application from the icons and names of the displayed local applications based on a detected ray event sent by the terminal device, to activate the i-th application, wherein i is any one integer from 1 to N, N is an integer greater than 0 and less than or equal to M, and M is the number of the local applications;
establishing an i-th canvas area corresponding to the i-th application in the display area, and recording a mapping relationship between the i-th canvas area and application attribute information of the i-th application; and
sending the mapping relationship to the terminal device, so that the terminal device activates, according to the mapping relationship, an i-th virtual screen to run the i-th application, and acquiring display data of the i-th virtual screen and sends it to the i-th canvas area for display.

According to a second aspect of the present disclosure, an interactive control method is provided, wherein the method includes:
receiving a mapping relationship sent by a head mounted display device, wherein the mapping relationship indicates the relationship between an i-th canvas area of the head mounted display device and application attribute information of an i-th application;

activating, according to the mapping relationship, an i-th virtual screen to run the i-th application;
acquiring display data of the i-th virtual screen; and
sending the display data of the i-th virtual screen to the i-th canvas area for display, wherein i is any one integer from 1 to N, N is an integer greater than 0 and less than or equal to M, and M is the number of local applications of a terminal device.

According to a third aspect of the present disclosure, an interactive control apparatus is provided, wherein the apparatus includes:
an acquisition module, configured to acquire application attribute information of local applications of a terminal device, wherein the application attribute information includes at least an icon and a name of a local application;
a display module, configured to display the icons and the names of the local applications in a display area of a head mounted display device;
a determination module, configured to, determine an icon and a name of an i-th application from the icons and names of the displayed local applications based on a detected ray event sent by the terminal device, to activate the i-th application, wherein i is any one integer from 1 to N, N is an integer greater than 0 and less than or equal to M, and M is the number of the local applications;
an establishment module, configured to establish an i-th canvas area corresponding to the i-th application in the display area, and record a mapping relationship between the i-th canvas area and application attribute information of the i-th application; and
a sending module, configured to send the mapping relationship to the terminal device, so that the terminal device activates, according to the mapping relationship, an i-th virtual screen to run the i-th application, and acquire display data of the i-th virtual screen and sends it to the i-th canvas area for display.

According to a fourth aspect of the present disclosure, an interactive control apparatus is provided, wherein the apparatus includes:
a receiving module, configured to receive a mapping relationship sent by a head mounted display device, wherein the mapping relationship indicates the relationship between an i-th canvas area of the head mounted display device and application attribute information of an i-th application;
an acquisition module, configured to acquire display data of an i-th virtual screen; and
a sending module, configured to send the display data of the i-th virtual screen to the i-th canvas area for display,
wherein i is any one integer from 1 to N, N is an integer greater than 0 and less than or equal to M, and M is the number of local applications of a terminal device.

According to a fifth aspect of the present disclosure, the electronic device includes: a memory configured to store an executable computer instruction; and a processor configured to execute the executable computer instruction to implement the interactive control method according to the first aspect or the second aspect as described above.

One beneficial effect of the disclosed embodiment is that it can acquire application attribute information of local applications of the terminal device, and the application attribute information includes at least the icon and the name of a local application, so that the icons and the names of the local applications can be displayed in the display area of the head-mounted display device, and based on the detected ray event sent by the terminal device, the icon and the name of the i-th application is determined from the icon and the name of the displayed local applications to activate the i-th application, and at the same time, the i-th canvas area corresponding to the i-th application is established in the display area, and the mapping relationship between the i-th canvas area and the application attribute information of the i-th application is recorded and sent to the terminal device, so that the terminal device activates, according to the mapping relationship, the i-th virtual screen to run the i-th application, and acquires the display data of the i-th virtual screen and sends it to the i-th canvas area for display. That is, the streaming content does not have to occupy the physical screen of the terminal device, and multiple applications can be activated in the streaming.

Other features and advantages of the present disclosure will become apparent from the following detailed description of exemplary embodiments of the present disclosure with reference to the attached drawings.

### BRIEF DESCRIPTION OF DRAWINGS

The accompanying drawings, which are incorporated in and constitute a part of the disclosure, illustrate embodiments of the disclosure and, together with the description, serve to explain the principles of the disclosure.

FIG. 1 is a schematic diagram of a hardware configuration of an interactive system according to an embodiment of the present disclosure.

FIG. 2 is a flow chart of an interactive control method according to an embodiment of the present disclosure.

FIG. 3 is a flow chart of an interactive control method according to another embodiment of the present disclosure.

FIG. 4 is a functional block diagram of an interactive control apparatus according to an embodiment of the present disclosure.

FIG. 5 is a functional block diagram of an interactive control apparatus according to another embodiment of the present disclosure.

FIG. 6 is a functional block diagram of an electronic device according to an embodiment of the present disclosure.

### DETAILED DESCRIPTIONS

Various exemplary embodiments of the present disclosure will now be described in detail with reference to the accompanying drawings. It should be noted that unless otherwise specifically stated, the relative arrangement of components and steps, numerical expressions and numerical values set forth in these embodiments do not limit the scope of the embodiments of the present disclosure.

The following description of at least one exemplary embodiment is merely illustrative in nature and is in no way intended to limit the present disclosure, its application, or uses.

Technologies, methods, and device known in the art may not be discussed in detail, but where appropriate, the technologies, methods, and device should be considered as part of the disclosure.

In all examples shown and discussed herein, any specific values should be interpreted as merely exemplary and not limiting. Therefore, other examples of the exemplary embodiments may have different values.

It should be noted that like reference numerals and letters refer to similar items in the following figures, and therefore, once an item is defined in one figure, it need not be further discussed in subsequent figures.

### Hardware Configuration

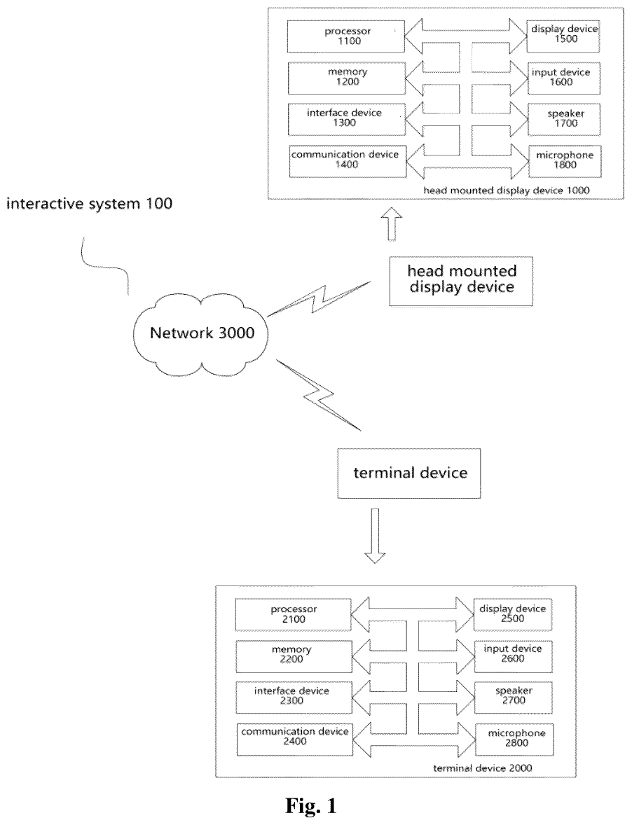

FIG. 1 is a block diagram of the hardware configuration of an interactive system according to an embodiment of the present disclosure. As shown in FIG. 1, the interactive system 10 includes a head mounted display device 1000 and a terminal device 2000, and the head mounted display device 1000 and the terminal device 2000 are connected to each other through a network 3000.

As shown in FIG. 1, the head mounted display device 1000 may be smart glasses, more specifically, may be AR glasses, and of course may be other devices, which is not limited in the embodiments of the present disclosure.

In an embodiment, as shown in FIG. 1, the head mounted display device 1000 may include a processor 1100, a memory 1200, an interface device 1300, a communication device 1400, a display device 1500, an input device 1600, a speaker 1700, a microphone 1800, and the like.

The processor 1100 may include but is not limited to a central processing unit CPU, a microprocessor MCU, etc. The memory 1200 includes, for example, a ROM (read-only memory), a RAM (random access memory), a non-volatile memory such as a hard disk, etc. The interface device 1300 includes, for example, various bus interfaces, such as a serial bus interface (including a USB interface), a parallel bus interface, etc. The communication device 1400 is capable of wired or wireless communication, for example. The display device 1500 is, for example, a liquid crystal display, an LED display, an OLED (Organic Light-Emitting Diode) display, etc. The input device 1600 includes, for example, a touch screen, a keyboard, a handle, etc. The head-mounted display device 1000 can output audio information through the speaker 1700 and can collect audio information through the microphone 1800.

It will be understood that, although multiple devices of the head-mounted display device 1000 are shown in FIG. 1, the head-mounted display device 1000 of the embodiment of the present disclosure may only involve some of the devices, or may further include additional devices, which is not limited herein.

In the embodiment, the memory 1200 of the head mounted display device 1000 is configured to store instructions, which are configured to control the processor 1100 to operate to implement or support the implementation of the interactive control method according to any embodiment. Those skilled in the art can design instructions according to the scheme disclosed in the present disclosure. How the instructions control the processor to operate is well known in the art, so it will not be described in detail here.

As shown in FIG. 1, the terminal device 2000 may be a mobile phone, a portable computer, etc.

In an embodiment, as shown in FIG. 1, the terminal device 2000 may include a processor 2100, a memory 2200, an interface device 2300, a communication device 2400, a display device 2500, an input device 2600, a speaker 2700, a microphone 2800, and the like.

The processor 1100 may include but is not limited to a central processing unit CPU, a microprocessor MCU, etc. The memory 2200 may include, for example, a ROM (read-only memory), a RAM (random access memory), a non-volatile memory such as a hard disk, etc. The interface device 2300 may include, for example, various bus interfaces, such as a serial bus interface (including a USB interface), a parallel bus interface, etc. The communication device 1400 may, for example, be capable of wired or wireless communication. The display device 2500 may, for example, be a liquid crystal display, an LED display, an OLED (Organic Light-Emitting Diode) display, etc. The input device 2600 may include, for example, a touch screen, a keyboard, a handle, etc. The terminal device 2000 may output audio information through the speaker 2700, and may collect audio information through the microphone 2800.

It can be understood that, although multiple devices of the terminal device 2000 are shown in FIG. 1, the terminal device 2000 of the embodiment of the present disclosure may only involve some of the devices, or may further include additional devices, which is not limited herein.

In the present embodiment, the memory 2200 of the terminal device 2000 is configured to store instructions, and the instructions are configured to control the processor 2100 to operate to implement or support the implementation of the interactive control method according to any embodiment. The technician can design instructions according to the scheme disclosed in the present disclosure. How the instructions control the processor to operate is well known in the art, so it will not be described in detail here.

It should be understood that although FIG. 1 shows only one head-mounted display device 1000 and one terminal device 2000, it does not mean to limit the respective quantities, and the interactive system 100 may include multiple head-mounted display devices 1000 and multiple terminal devices 2000.

### Method Embodiment 1

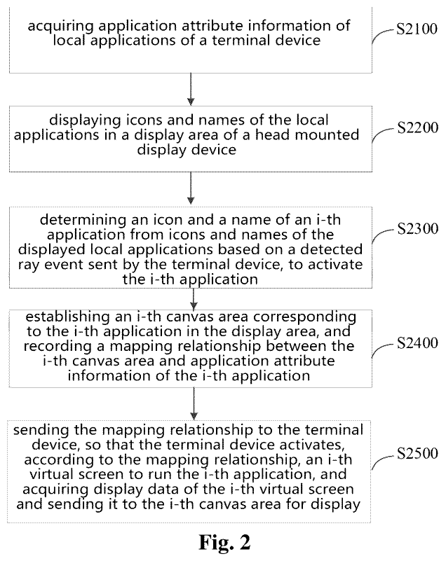

FIG. 2 shows an interactive control method according to an embodiment of the present disclosure. The interactive control method may be implemented by a head-mounted display device, or may be implemented jointly by a control apparatus independent of the head-mounted display device and the head-mounted display device, or may be implemented jointly by a cloud server and the head-mounted display device.

As shown in FIG. 2, the interactive control method of the embodiment may include the following steps S2100 to S2500.

Step S2100: acquiring application attribute information of local applications of the terminal device.

The application attribute information includes at least an icon and a name of a local application.

Optionally, the step S2100 of acquiring application attribute information of local applications of the terminal device may further include: acquiring application attribute information of the local applications of the terminal device based on a wireless streaming connection established between the head mounted display device and the terminal device.

In a specific embodiment, the head-mounted display device is smart glasses such as AR glasses, and the terminal device is a mobile phone. For example, the mobile phone and the AR glasses establish a wireless streaming connection. At this time, the content displayed on the physical screen of the mobile phone is the control interface of the mobile phone as a handle, and the content on the physical screen of the mobile phone does not need to be transmitted to the AR glasses. While the mobile phone and the AR glasses establish a wireless streaming connection, the mobile phone extracts the application attribute information of the local applications and transmits the application attribute information of the local applications to the AR glasses.

Then, the process proceeds to step S2200, where the icons and the names of the local applications are displayed on the display area of the head mounted display device.

In a specific embodiment, the AR glasses receive application attribute information of local applications sent by the mobile phone, such as the icon and the name of the application, and display the icon and the name of the application on the display area (i.e., the Launcher) of the AR glasses.

Then, the process proceeds to step S2300, where the icon and the name of the i-th application are determined from the icon and the name of the displayed local applications based on the detected ray event sent by the terminal device, to activate the i-th application.

Here, i is any one integer from 1 to N, N is an integer greater than 0 and less than or equal to M, and M is the number of the local applications.

Optionally, before performing step S2300, a step of determining whether a ray event sent by a terminal device is detected can be performed, specifically, it may include: acquiring posture information of the terminal device; controlling the virtual ray to rotate according to the posture information; and determining that the ray event sent by the terminal device is detected when an intersection of the virtual ray and the display area points to the icon or name of a certain application (e.g., the i-th application).

The posture information of the terminal device can be calculated through the IMU data of the terminal device.

Then, the process proceeds to step S2400, where an i-th canvas area corresponding to the i-th application is established in the display area, and a mapping relationship between the i-th canvas area and application attribute information of the i-th application is recorded.

In a specific embodiment, the AR glasses determine that an application is activated based on the ray event, create a canvas area texture corresponding to the application, and number the canvas area. At the same time, a mapping relationship is established based on the canvas area number and the application name, and the mapping relationship is transmitted to the mobile phone.

Then, the process proceeds to step S2500, where the mapping relationship is sent to the terminal device, so that the terminal device activates, according to the mapping relationship, the i-th virtual screen to run the i-th application, and the display data of the i-th virtual screen is acquired and sent to the i-th canvas area for display.

In a specific embodiment, the mobile phone activates the corresponding virtual screen on the mobile phone to run the application according to the mapping relationship, that is, the number of the canvas area and the name of the application. At the same time, the mobile phone sends the display data of the application to the corresponding canvas area for display. Here, based on the above steps S2200 to S2500, the display of multiple applications can be realized.

According to the embodiment of the present disclosure, it is possible to acquire application attribute information of local applications of the terminal device, and the application attribute information includes at least the icon and name of the application, so that the icons and names of the local applications are displayed in the display area of the head-mounted display device, and based on the detected ray event sent by the terminal device, the icon and name of the i-th application are determined from the icons and names of the displayed local applications to activate the i-th application, and at the same time, the i-th canvas area corresponding to the i-th application is established in the display area, and the mapping relationship between the i-th canvas area and the application attribute information of the i-th application is recorded and sent to the terminal device, so that the terminal device activates, according to the mapping relationship, the i-th virtual screen to run the i-th application, and acquires the display data of the i-th virtual screen and sends it to the i-th canvas area for display. That is, the streaming content does not have to occupy the physical screen of the terminal device, and multiple applications can be activated by using the streaming.

In an embodiment, after the mapping relationship is sent to the terminal device, the interactive control method of the embodiment of the present disclosure further includes the following steps S3100 to S3200:

Step S3100: receiving a touch input of a user on a display interface of the terminal device sent by the terminal device.

The touch input may be a click input on the display interface of the terminal device, which is not limited in the embodiment.

Step S3200: sending the position information of the first position to the terminal device in response to the touch input, so that the terminal device determines the position information of the second position corresponding to the first position in the target virtual screen according to the position information of the first position, and executes the interactive event triggered for the second position according to the position information of the second position.

The first position is the relative position of the intersection of the virtual ray and the target canvas area in the target canvas area, and the target virtual screen corresponds to the target canvas area. Optionally, the AR glasses may first acquire the position information of the second position of the intersection of the virtual ray and the target canvas area, and the position information of a third position of the target canvas area, and then acquire the position information of the first position according to the position information of the second position and the position information of the third position.

It can be understood that the position information of the third position of the target canvas area may be the position information of the target canvas area in the world coordinate system.

According to the embodiments of the present disclosure, after the mobile phone is turned on the application, the interaction with the virtual screen in the mobile phone can be achieved through the head-mounted display device.

### Method Embodiment 2

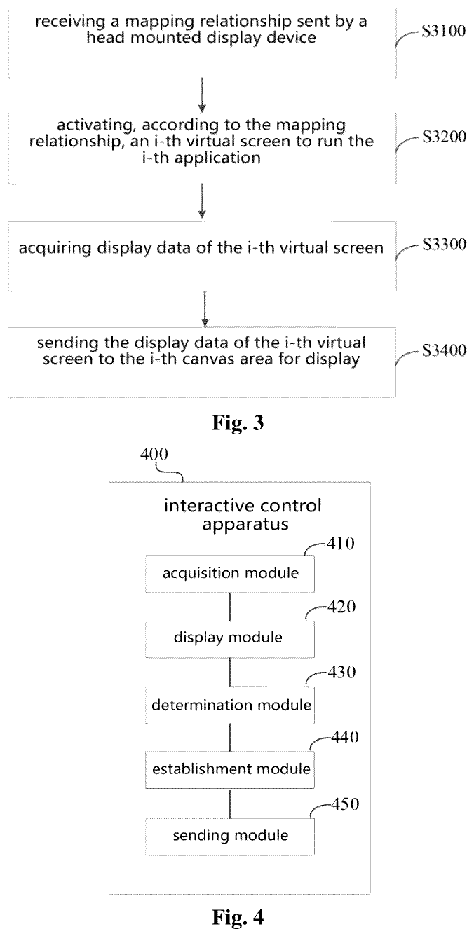

FIG. 3 shows an interactive control method according to an embodiment of the present disclosure. The interactive control method may be implemented by a terminal device, or implemented jointly by a control apparatus independent of the terminal device and the terminal device, or implemented jointly by a cloud server and the terminal device.

As shown in FIG. 3, the interactive control method of the embodiment may include the following steps S3100 to S3400:
Step S3100: receiving a mapping relationship sent by a head mounted display device, wherein the mapping relationship indicates the relationship between an i-th canvas area of the head mounted display device and application attribute information of an i-th application.
Step S3200: activating, according to the mapping relationship, the i-th virtual screen to run the i-th application.
Step S3300: acquiring display data of the i-th virtual screen.
Step S3400: sending the display data of the i-th virtual screen to the i-th canvas area for display.

Herein, i is any one integer from 1 to N, N is an integer greater than 0 and less than or equal to M, and M is the number of local applications of the terminal device.

According to the embodiment of the present disclosure, it can receive mapping data sent by the head mounted display device, the mapping relationship indicating the relationship between the i-th canvas area of the head mounted display device and the application attribute information of the i-th application, activate, according to the mapping relationship, the i-th virtual screen to run the i-th application, and acquire the display data of the i-th virtual screen, to send the display data of the i-th virtual screen to the i-th canvas area for display. That is, the streaming content does not have to occupy the physical screen of the terminal device, and multiple applications can be activated in the streaming.

In an embodiment, after the display data of the i-th virtual screen is sent to the i-th canvas area for display, the interactive control method of the embodiment of the present disclosure further includes the following steps S4100 to S4400.
Step S4100: receiving a touch input of a user on the display interface of the terminal device.
Step S4200: sending the touch input to the head mounted display device, and receiving position information of a first position sent back from the head mounted display device in response to the touch input, wherein the first position is a relative position of an intersection of a virtual ray and a target canvas area in the target canvas area.
Step S4300: determining the position information of a second position in the target virtual screen corresponding to the first position according to the position information of the first position, wherein the target virtual screen corresponds to the target canvas area.
Step S4400: executing an interactive event triggered for the second position according to the position information of the second position.

According to the embodiments of the present disclosure, after the mobile phone is turned on the application, the interaction with the virtual screen in the mobile phone can be achieved through the head-mounted display device.

### Example

Next, an example of an interactive control method is shown, taking the head mounted display device as AR glasses and the terminal device as a mobile phone. The interactive control method may include the following steps:
Step S601: the mobile phone and the AR glasses establish a wireless streaming connection. At this time, the content displayed on the physical screen of the mobile phone is the control interface of the mobile phone as a handle, and the content on the physical screen of the mobile phone does not need to be transmitted to the AR glasses.
Step S602: the mobile phone extracts application attribute information of the local applications and sends the application attribute information to the AR glasses.
Step S603: the AR glasses receive application attribute information of the local applications of the mobile phone, and display the icons and the names of the local applications of the mobile phone in the display area of the AR glasses.
Step S604: the AR glasses determine the icon and the name of the application to be activated from the icons and names of the displayed local applications based on the detected ray event sent by the terminal device, and activate the application. A canvas area corresponding to the application is established in the display area, and the mapping relationship between the number of the canvas area and the name of the application is recorded and sent to the mobile phone.
Step S605: the mobile phone receives the mapping relationship between the number of the canvas area and the name of the application, and activates the corresponding virtual screen to run the application. At the same time, the mobile phone sends the display data of the virtual screen to the corresponding canvas area for display. If other applications are activated, the above steps S604 and step S605 can be repeated.
Step S606: the user controls the ray operation application through the IMU information of the mobile phone, and the AR glasses calculate the relative position of the intersection in the canvas area based on the coordinate value of the intersection of the received ray and the canvas area and the coordinate value of the canvas area in the world coordinate system, and transmit the relative position to the mobile phone in real time.
Step S607: the mobile phone receives the relative position transmitted by the AR glasses and the click event in the controller, calculates the corresponding mapping position in the virtual screen according to the relative position, and triggers the touch event to complete the interaction with the virtual screen.

### Apparatus Embodiment 1

FIG. 4 is a schematic diagram of an interactive control apparatus according to an embodiment. As shown in FIG. 4, the apparatus 400 includes an acquisition module 410, a display module 420, a determination module 430, an establishment module 440 and a sending module 450.

The acquisition module 410 is configured to acquire application attribute information of local applications of the terminal device, wherein the application attribute information includes at least an icon and a name of a local application.

The display module 420 is configured to display the icons and the names of the local applications in the display area of the head mounted display device.

The determination module 430 is configured to determine the icon and name of the i-th application from the icons and names of the displayed local applications based on the detected ray event sent by the terminal device, to activate the i-th application, wherein i is any one integer from 1 to N, N is an integer greater than 0 and less than or equal to M, and M is the number of the local applications.

The establishment module 440 is configured to establish an i-th canvas area corresponding to the i-th application in the display area, and record the mapping relationship between the i-th canvas area and the application attribute information of the i-th application.

The sending module 450 is configured to send the mapping relationship to the terminal device, so that the terminal device activates, according to the mapping relationship, the i-th virtual screen to run the i-th application, and acquire the display data of the i-th virtual screen and sends it to the i-th canvas area for display.

In an embodiment, the apparatus 400 further includes an acquisition module and a control module (neither of which are shown in the drawings).

The acquisition module is configured to acquire the posture information of the terminal device.

The control module is configured to control the virtual ray to rotate according to the posture information.

The determination module 430 is configured to determine that the ray event sent by the terminal device is detected when the intersection of the virtual ray and the display area points to the icon or name of the i-th application.

In an embodiment, the apparatus 400 further includes a receiving module (not shown in the drawings).

The receiving module is configured to receive a touch input of a user on a display interface of the terminal device sent by the terminal device.

The sending module 450 is configured to send the position information of the first position to the terminal device in response to the touch input, so that the terminal device determines the position information of the second position corresponding to the first position in the target virtual screen according to the position information of the first position, and executes the interactive event triggered for the second position according to the position information of the second position.

The first position is the relative position of the intersection of the virtual ray and the target canvas area in the target canvas area, and the target virtual screen corresponds to the target canvas area.

In an embodiment, the acquisition module 410 is further configured to acquire position information of a second position of the intersection of the virtual ray and the target canvas area; acquire position information of a third position of the target canvas area; and acquire position information of the first position according to the position information of the second position and the position information of the third position.

According to the embodiment of the present disclosure, it is possible to acquire application attribute information of local applications of the terminal device, and the application attribute information includes at least the icon and name of the application, so that the icons and names of the local applications are displayed in the display area of the head-mounted display device, and based on the detected ray event sent by the terminal device, the icon and name of the i-th application are determined from the icons and names of the displayed local applications to activate the i-th application, and at the same time, the i-th canvas area corresponding to the i-th application is established in the display area, and the mapping relationship between the i-th canvas area and the application attribute information of the i-th application is recorded and sent to the terminal device, so that the terminal device activates, according to the mapping relationship, the i-th virtual screen to run the i-th application, and acquires the display data of the i-th virtual screen and sends it to the i-th canvas area for display. That is, the streaming content does not have to occupy the physical screen of the terminal device, and multiple applications can be activated in the streaming.

### Apparatus Embodiment 2

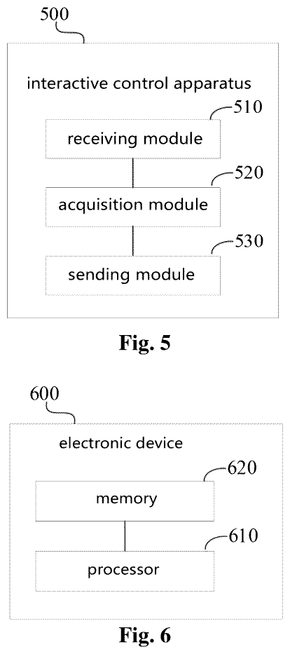

FIG. 5 is a schematic diagram of the principle of an interactive control apparatus according to an embodiment. As shown in FIG. 5, the apparatus 500 includes a receiving module 510, an acquisition module 520 and a sending module 530.

The receiving module 510 is configured to receive a mapping relationship sent by a head mounted display device, wherein the mapping relationship indicates the relationship between the i-th canvas area of the head mounted display device and the application attribute information of the i-th application.

The acquisition module 520 is configured to acquire display data of an i-th virtual screen.

The sending module 530 is configured to send the display data of the i-th virtual screen to the i-th canvas area for display, Herein, i is any one integer from 1 to N, N is an integer greater than 0 and less than or equal to M, and M is the number of local applications of the terminal device.

In an embodiment, the apparatus further includes a determination module and an execution module (not shown in the drawings).

The receiving module 510 is configured to receive a touch input of a user on the display interface of the terminal device.

The sending module 530 is configured to send the touch input to the head mounted display device.

The receiving module 510 is configured to receive the position information of the first position sent back from the head mounted display device in response to the touch input, wherein the first position is the relative position of the intersection of the virtual ray and the target canvas area in the target canvas area.

The determination module is configured to determine the position information of a second position in a target virtual screen corresponding to the first position based on the position information of the first position, wherein the target virtual screen corresponds to the target canvas area.

The execution module is configured to execute an interactive event triggered at the second position according to the position information of the second position.

According to the embodiment of the present disclosure, it can receive mapping data sent by the head mounted display device, the mapping relationship indicating the relationship between the i-th canvas area of the head mounted display device and the application attribute information of the i-th application, activate, according to the mapping relationship, the i-th virtual screen to run the i-th application, and acquire the display data of the i-th virtual screen, to send the display data of the i-th virtual screen to the i-th canvas area for display. That is, the streaming content does not have to occupy the physical screen of the terminal device, and multiple applications can be activated in the streaming.

### Device Embodiment

FIG. 6 is a schematic diagram of the hardware structure of an electronic device according to an embodiment. As shown in FIG. 6, the electronic device 600 includes a processor 610 and a memory 620.

The memory 620 may be configured to store an executable computer instruction.

The processor 610 can be configured to execute the interactive control method described in the embodiment of the method of the present disclosure under the control of the executable computer instructions.

The electronic device 600 may be the head mounted display device 1000 as shown in FIG. 1, or may be the terminal device 2000 as shown in FIG. 1, which is not limited herein.

In another embodiment, the electronic device 600 may include the above interactive control apparatus 400 and interactive control apparatus 500.

In an embodiment, each module of the above interactive control apparatus 400 and the interactive control apparatus 500 can be implemented by the processor 610 running computer instructions stored in the memory 620.

The present disclosure may be a system, a method and/or a computer program product. The computer program product may include a computer-readable storage medium carrying computer-readable program instructions for causing a processor to implement various aspects of the present disclosure.

A computer-readable storage medium may be a tangible device that can hold and store instructions used by an instruction execution device. A computer-readable storage medium may be, for example, but not limited to, an electrical storage device, a magnetic storage device, an optical storage device, an electromagnetic storage device, a semiconductor storage device, or any suitable combination of the above. More specific examples (a non-exhaustive list) of computer-readable storage media include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical encoding device, such as a punch card or a raised structure in a groove on which instructions are stored, and any suitable combination of the above. The computer-readable storage medium used herein is not to be interpreted as a transient signal itself, such as a radio wave or other freely propagating electromagnetic wave, an electromagnetic wave propagating through a waveguide or other transmission medium (e.g., a light pulse through a fiber optic cable), or an electrical signal transmitted through a wire.

The computer-readable program instructions described herein can be downloaded from a computer-readable storage medium to each computing/processing device, or downloaded to an external computer or external storage device via a network, such as the Internet, a local area network, a wide area network, and/or a wireless network. The network can include copper transmission cables, optical fiber transmissions, wireless transmissions, routers, firewalls, switches, gateway computers, and/or edge servers. The network adapter card or network interface in each computing/processing device receives the computer-readable program instructions from the network and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-dependent instructions, microcode, firmware instructions, state setting data, or source code or object code written in any combination of one or more programming languages, including object-oriented programming languages, such as Smalltalk, C++, etc., and conventional procedural programming languages, such as “C” language or similar programming languages. The computer-readable program instructions may be executed entirely on the user's computer, partially on the user's computer, as a separate software package, partially on the user's computer, partially on a remote computer, or entirely on a remote computer or server. In the case of a remote computer, the remote computer may be connected to the user's computer through any type of network, including a local area network (LAN) or a wide area network (WAN), or may be connected to an external computer (e.g., using an Internet service provider to connect through the Internet). In some embodiments, by using the state information of the computer-readable program instructions to personalize an electronic circuit, such as a programmable logic circuit, a field programmable gate array (FPGA), or a programmable logic array (PLA), the electronic circuit may execute the computer-readable program instructions, thereby implementing various aspects of the present disclosure.

Various aspects of the present disclosure are described herein with reference to flowcharts and/or block diagrams of methods, devices (systems) and computer program products according to embodiments of the present disclosure. It should be understood that each box in the flowchart and/or block diagram and the combination of boxes in the flowchart and/or block diagram can be implemented by computer-readable program instructions.

These computer-readable program instructions can be provided to a processor of a general-purpose computer, a special-purpose computer, or other programmable data processing device, thereby producing a machine, so that when these instructions are executed by the processor of the computer or other programmable data processing device, a device that implements the functions/actions specified in one or more boxes in the flowchart and/or block diagram is generated. These computer-readable program instructions can also be stored in a computer-readable storage medium, and these instructions cause the computer, programmable data processing device, and/or other device to work in a specific manner, so that the computer-readable medium storing the instructions includes a manufactured product, which includes instructions for implementing various aspects of the functions/actions specified in one or more boxes in the flowchart and/or block diagram.

Computer-readable program instructions may also be loaded onto a computer, other programmable data processing apparatus, or other device so that a series of operating steps are performed on the computer, other programmable data processing apparatus, or other device to produce a computer-implemented process, thereby causing the instructions executed on the computer, other programmable data processing apparatus, or other device to implement the functions/actions specified in one or more boxes in the flowchart and/or block diagram.

The flowcharts and block diagrams in the accompanying drawings show the possible architecture, functions and operations of the systems, methods and computer program products according to multiple embodiments of the present disclosure. In this regard, each box in the flowchart or block diagram can represent a module, a program segment or a part of an instruction, and the module, a program segment or a part of an instruction contains one or more executable instructions for realizing the specified logical function. In some alternative implementations, the functions marked in the box can also occur in a different order from the order marked in the accompanying drawings. For example, two consecutive boxes can actually be executed substantially in parallel, and they can sometimes be executed in the opposite order, depending on the functions involved. It should also be noted that each box in the block diagram and/or the flowchart, and the combination of the boxes in the block diagram and/or the flowchart can be implemented by a dedicated hardware-based system that performs the specified function or action, or can be implemented by a combination of dedicated hardware and computer instructions. It should be understood that it is equivalent to implement it by hardware, implement it by software, and implement it by combining software and hardware.

The embodiments of the present disclosure have been described above, and the above description is exemplary, not exhaustive, and is not limited to the disclosed embodiments. Many modifications and changes will be apparent to those of ordinary skill in the art without departing from the scope and spirit of the described embodiments. The choice of terms used herein is intended to best explain the principles of the embodiments, practical applications, or technical improvements in the marketplace, or to enable other persons of ordinary skill in the art to understand the embodiments disclosed herein. The scope of the present disclosure is defined by the appended claims.

1. An interactive control method, wherein the method comprises:
acquiring application attribute information of local applications of a terminal device, wherein the application attribute information comprises at least an icon and a name of a local application;
displaying the icons and the names of the local applications in a display area of a head mounted display device;
determining an icon and a name of an i-th application from the icon and the name of the displayed local applications based on a detected ray event sent by the terminal device, to activate the i-th application, wherein i is any one integer from 1 to N, N is an integer greater than 0 and less than or equal to M, and M is a number of the local applications;
establishing an i-th canvas area corresponding to the i-th application in the display area, and recording a mapping relationship between the i-th canvas area and application attribute information of the i-th application; and
sending the mapping relationship to the terminal device, so that the terminal device activates, according to the mapping relationship, an i-th virtual screen to run the i-th application, and acquiring display data of the i-th virtual screen and sends it to the i-th canvas area for display.

2. The method according to claim 1, wherein the method further comprises:
acquiring posture information of the terminal device; and
controlling virtual ray to rotate according to the posture information; and
determining that the ray event sent by the terminal device is detected when an intersection point of the virtual ray and the display area points to the icon or name of the i-th application.

3. The method according to claim 1, wherein after the sending the mapping relationship to the terminal device, the method further comprises:
receiving a touch input of a user on a display interface of the terminal device sent by the terminal device; and
sending position information of a first position to the terminal device in response to the touch input, so that the terminal device determines position information of a second position corresponding to the first position in a target virtual screen according to the position information of the first position, and executes an interactive event triggered for the second position according to the position information of the second position,
wherein the first position is a relative position of an intersection of a virtual ray and a target canvas area in the target canvas area, and the target virtual screen corresponds to the target canvas area.

4. The method according to claim 3, wherein the method further comprises acquiring the position information of the first position,
wherein the acquiring the position information of the first position comprises:
acquiring the position information of the second position of the intersection of the virtual ray and the target canvas area;
acquiring position information of a third position of the target canvas area; and
acquiring the position information of the first position according to the position information of the second position and the position information of the third position.

5. The method according to claim 1, wherein the acquiring the application attribute information of the local applications of the terminal device comprises:
acquiring the application attribute information of the local applications of the terminal device based on a wireless streaming connection established between the head mounted display device and the terminal device.

6. An interactive control method, wherein the method comprises:
receiving a mapping relationship sent by a head mounted display device, wherein the mapping relationship indicates a relationship between an i-th canvas area of the head mounted display device and application attribute information of an i-th application;
activating, according to the mapping relationship, an i-th virtual screen to run the i-th application;
acquiring display data of the i-th virtual screen; and
sending the display data of the i-th virtual screen to the i-th canvas area for display,
wherein i is any one integer from 1 to N, N is an integer greater than 0 and less than or equal to M, and M is a number of local applications of a terminal device.

7. The method according to claim 6, wherein after the sending the display data of the i-th virtual screen to the i-th canvas area for display, the method further comprises:
receiving a touch input of a user on a display interface of the terminal device;
sending the touch input to the head mounted display device, and receiving position information of a first position sent back from the head mounted display device in response to the touch input, wherein the first position is a relative position of an intersection of a virtual ray and a target canvas area in the target canvas area;
determining position information of a second position corresponding to the first position in a target virtual screen according to the position information of the first position, wherein the target virtual screen corresponds to the target canvas area; and
executing an interactive event triggered for the second position according to the position information of the second position.

8. (canceled)

9. (canceled)

10. An electronic device, wherein the electronic device comprises:
a memory configured to store an executable computer instruction; and
a processor configured to execute the executable computer instruction to implement the interactive control method according to claim 1.

11. An electronic device, wherein the electronic device comprises:
a memory configured to store an executable computer instruction; and
a processor configured to execute the executable computer instruction to implement the interactive control method according to claim 6.
